(19) United States
(12) Patent Application Publication
(10) Pub. No.: US 2004/0004417 A1
(43) Pub. Date: Jan. 8, 2004

(54) Modular furniture system and associated method of assembly

(76) Inventor: Wayne Turett, New York, NY (US)

Correspondence Address: LaMorte & Associates, P.C., P.O. Box 434, Yardley, PA, 19067-8434, US

(21) Appl. No.: 10/189,685

(22) Filed: Jul. 8, 2002

(51) Int. Cl. A47B 43/00; F16B 12/00

(52) U.S. Cl. 312/257.1; 312/111

(57) ABSTRACT

A modular furniture system and its associated method of assembly. The modular furniture system contains a plurality of panels. The panels can be of any color and/or decorative texture. The panels are held in place by a rigid framework. The rigid framework is custom created by joining together a plurality of framing elements with a plurality of connection brackets. The framing elements are tubular structures with open ends. At least some of said framing elements have flanges extending therefrom that engage and support the panels. The connection brackets each have arms that pass into, and engage, the open ends of the framing elements. By providing several connection brackets of different configurations and a few framing elements of different configurations, a wide variety of furniture can be selectively created.

### BACKGROUND OF THE INVENTION

1. Field of the Invention

The present invention relates to modular furniture systems. More particularly, the present invention relates to modular furniture systems that are comprised of a few basic component parts that can be assembled into multiple different configurations of furniture.

2. Prior Art Statement

The prior art is replete with different types of furniture and furniture systems. Furniture is a broad area of art that comprises a wide variety of different technologies. Fine furniture is typically furniture that is carved from wood and may be upholstered. Fine furniture is bought preassembled. Kit furniture is furniture that is bought unassembled. The pieces of the furniture are preformed and can only be assembled into one configuration. Such furniture is popular in low price furniture retails stores because the furniture need not be delivered. Rather, customers can purchase the furniture unassembled in small boxes. The furniture can then be easily transported to homes or apartments and assembled in place.

A third class of furniture is modular furniture. Modular furniture is neither preassembled nor sold in designated unassembled kits. Rather, modular furniture systems have a variety of component parts. The component parts can be arranged in a variety of different configurations to create furniture of most any size, shape and purpose. Modular furniture systems are often used to create cubicles in offices because the needs and shapes of most every office differ. As such, a modular furniture system enables a customer to buy component pieces and custom design the furniture to fit the needs of that office. Modular furniture systems are exemplified by U.S. Pat. No. 5,893,617 to Lee, entitled Connecting Assembly For Horizontal Boards And Wall Boards Of A Cabinet.

However, since modular furniture systems have only a few basic component pieces, the furniture that can be created with such systems is limited in its shape and aesthetic appeal.

The present invention sets forth an improved modular furniture system that enables different furniture pieces to be created in a wide variety of shapes and styles. The present invention system also enables people to customize color, textures and other details in a manner previously unachievable using prior art modular furniture systems. This new modular furniture system and its associated method of assembly are set forth in the specification and claims presented below.

### SUMMARY OF THE INVENTION

The present invention is a modular furniture system and its associated method of assembly. The modular furniture system contains a plurality of panels. The panels can be of any color and/or decorative texture. The panels are held in place by a rigid framework. The rigid framework is custom created by joining together a plurality of framing elements with a plurality of connection brackets. The framing elements are tubular structures with open ends. At least some of said framing elements have flanges extending therefrom that engage and support the panels. The connection brackets each have arms that pass into, and engage, the open ends of the framing elements. By providing several connection brackets of different configurations and a few framing elements of different configurations, a wide variety of furniture can be selectively created.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of piece of furniture built using the present invention modular furniture system;

FIG. 2 is a perspective view of exemplary embodiments of panels used within the present invention modular furniture system;

FIG. 3 is a perspective view of exemplary embodiments of framing elements used within the present invention modular furniture system;

FIG. 4 is a perspective view of exemplary embodiments of brackets used within the present invention modular furniture system;

FIG. 5 is a perspective view of exemplary embodiments of end terminations used within the present invention modular furniture system; and

FIG. 6 shows the exemplary piece of assembled furniture shown previously in FIG. 1, identified by its component parts.

### DETAILED DESCRIPTION OF THE INVENTION

Although the present invention system can be used to create many different types of furniture, such as storage shelves, display cases and the like, the present invention system is particularly useful in creating office workstations and similar furniture having exposed counters. As such, by way of example, the present invention system will be illustrated and described in creating an office workstation. Such an embodiment is merely exemplary and is not intended to be a limitation on the possible applications of the present invention system.

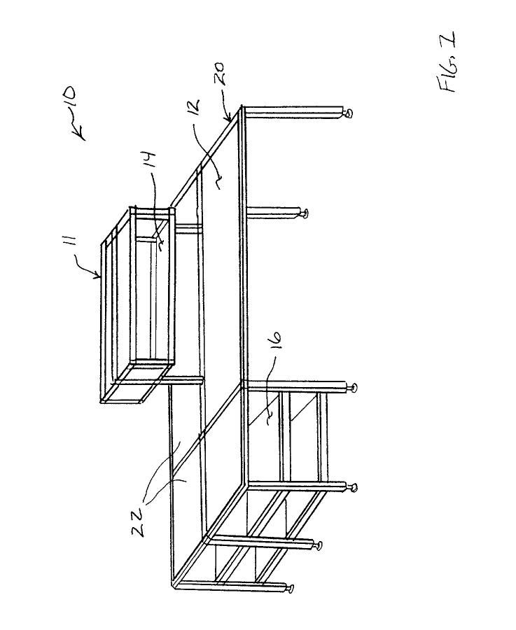

Referring to FIG. 1, an exemplary embodiment of the modular furniture system 10 is shown configured as a workstation 11. The workstation 11 is of the style used in many modern offices. As will be explained, the workstation 11 is made from the interconnection of a plurality of different parts. It is these component parts that can be assembled in a countless number of ways to custom create workstations or nearly any other piece of furniture.

In the shown embodiment, the workstation 11 has desktop space 12, shelf space 14 and storage space 16. Each area is created using the same basic component parts. The basic component parts are used to create a metal framework 20. The metal framework 20 is rigid when assembled and is self-supporting on the floor. The metal framework 20 supports horizontal and vertical panels 22. It is the horizontal and vertical panels 22 that create the desktop space 12, shelf space 14 and storage space 16.

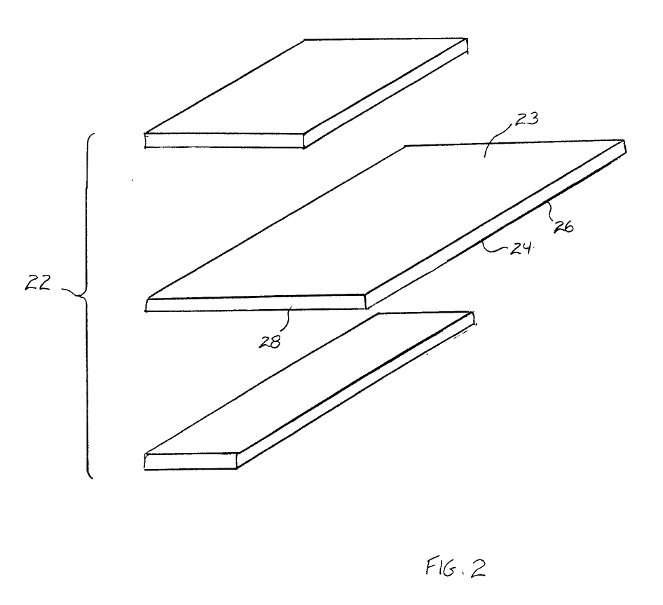

The present invention modular furniture system 10 is comprised of four major families, or types, of parts. These families of parts are shown in FIGS. 2-5, respectively. The first family of parts are the panels 22. Referring to FIG. 2, it can be seen that the panels 22 are planar structures having flat top surfaces 23 and flat bottom surfaces 24 that share the same peripheral edge 26. The panels 22 are manufactured in a large variety of lengths and widths. As such, a designer can select panels 22 of most any dimension in creating a piece of furniture. The panels 22 can be made from many different materials including natural materials, such as wood, marble or stone. Manmade products, such as mdf, Fin ply (TM), Corian(TM) or glass can also be used. Furthermore, composite materials, such as board reinforced Formica(TM) can be used as well. As such, it will be understood that the panels 22 can be produced in any color or can have any pattern achievable with traditional countertop products.

Framing elements are the second type of component part used in the modular furniture system. Each framing element is an elongated tubular element that can be manufactured in a variety of different lengths. Each of the framing elements is uniform in its structure along its length. As such, if a framing element does have to be custom cut in length, the cut has no effect of the functionality of the framing element.

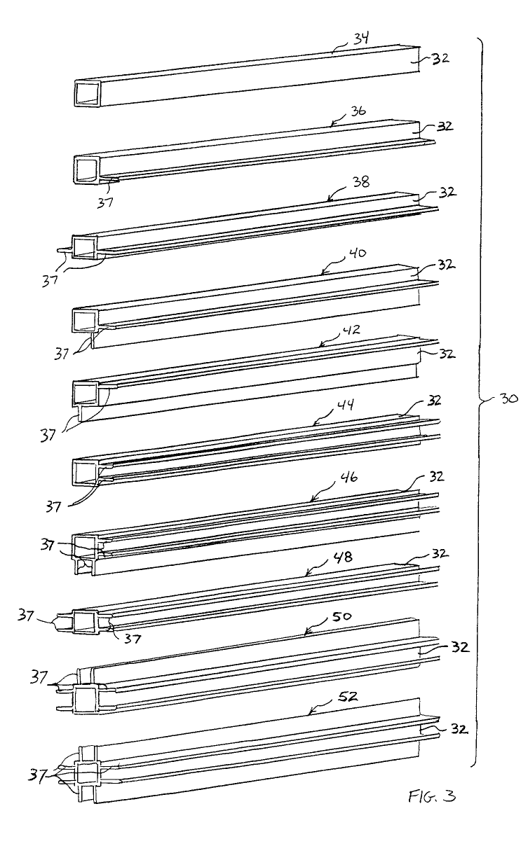

In FIG. 3, ten different types of framing elements 30 are shown. Each of the ten types of framing elements 30 has a tubular shaft 32 of the same dimensions. In the shown embodiment, each tubular shaft 32 has a square profile, however profiles of other shapes can also be used.

The first type of framing element 30 shown is a plain framing element 34. The plain framing element 34 is used in the modular furniture system to produce legs and other vertical supports where the plain framing element 34 does not directly engage a panel. The second type of framing element 30 is a single panel framing element 36. The single panel framing element 36 has at least one flange extension 37 protruding from one side of the tubular shaft 32. The flange extensions 37 are sized and positioned to produce a ledge along the length of the tubular shaft 32 against which the edge of a panel can lay. Since the single panel framing element 36 has a flange extension 37 along only one side, a panel 22 (FIG. 2) will only lay along one side of the single panel framing element 36.

The third type of framing element 30 shown is a two-sided framing element 38. The two-sided framing element 38 is used along countertops where two panels 22 (FIG. 2) are joined together in a common plane. The two-sided framing element 30 has flange extensions 37 protruding from two opposite sides of the tubular shaft 32. The flange extensions 37 are sized and positioned to form ledges on which the peripheral edge of two separate panels 22 (FIG. 2) can lay. Since the two-sided framing element 38 has flange extensions 37 along two opposite sides, two panels 22 (FIG. 2) can be interconnected to opposite sides of the two sided framing element 40, thereby joining the two panels in a common plane.

The fourth type of framing element 30 shown is an interior right angle framing element 40. The interior right angle framing element 40 is used along corner edges where two panels meet at a right angle. The interior right angle framing element 40 has two flange extensions 37 protruding from two adjacent sides of the tubular shaft 32, near a common corner. The flange extensions 37 are sized and positioned to create ledges that support the peripheral edge of two separate panels 22 (FIG. 2). Since the interior right angle framing element 40 has flange extensions 37 along only two adjacent sides, two panels 22 (FIG. 2) can be interconnected to the interior right angle framing element 40 along perpendicular planes that intersect along the length of the interior right angle framing element 40.

The fifth type of framing element 30 shown is an exterior right angle framing element 42. The exterior right angle framing element 42 is used along corner edges where two panels meet at a right angle. The exterior right angle framing element 38 has two flange extensions 37 protruding from two adjacent sides of the tubular shaft 32. However, the two flange extensions 37 are positioned near opposite corners of the tubular shaft 32. The flange extensions 37 are sized and positioned to create ledges that support the peripheral edge of two separate panels 22 (FIG. 2). Since the exterior right angle framing element 42 has flange extensions 37 along only two adjacent sides, two panels 22 (FIG. 2) can be interconnected to the exterior right angle framing element 42 along perpendicular planes that intersect along the length of the exterior right angle framing element 42. However, due to the position of the flange extensions 37, the exterior right angle framing element 42 supports panels in the direction directly opposite that of the interior right angle framing elements 40, previously described.

The sixth type of framing element 30 shown is a single-panel double-flanged framing element 44. The single-panel double-flanged framing element has two flange extensions 37 extending in parallel from the same side of the tubular shaft 32. A distance Dl exists between the two parallel flange extensions 37. This distance corresponds to the thickness of one of the panels 22 (FIG. 2). Consequently, the edge of one of the panels can slide in between the two parallel flange extensions 37. The panel is therefore preventing from moving in two directions. The single-panel double-flanged framing element 44 is used where a panel is held vertically and gravity cannot be relied upon to bias the panel against any single flange extension.

The seventh type of framing element 30 shown is a double-flanged right angle framing element 46. The double-flanged right angle framing element 46 is used along corner edges where two panels meet at a right angle. The double-flanged right angle framing element 46 has two sets of parallel flange extensions 37 protruding from two adjacent sides of the tubular shaft 32. The sets of parallel flange extensions 37 are sized and positioned to receive the peripheral edge of two separate panels 22 (FIG. 2). Since the double-flanged right angle framing element 46 has sets of flange extensions 37 along two adjacent sides, two panels 22 (FIG. 2) can be interconnected to the double-flanged right angle framing element 46 along perpendicular planes that intersect along the length of the double-flanged right angle framing element 46.

The eighth type of framing element 30 shown is a double-flanged two-panel framing element 48. The double-flanged two-panel framing element 48 is used along flat surfaces where two panels meet in the same plane. The double-flanged two-panel framing element 48 has two sets of parallel flange extensions 37 protruding from opposite sides of the tubular shaft 32. The sets of parallel flange extensions 37 are sized and positioned to receive the peripheral edge of two separate panels 22 (FIG. 2). Since the double-flanged two-panel framing element 48 has sets of flange extensions 37 along two opposite sides, two panels 22 (FIG. 2) can be interconnected to the double-flanged two-panel framing element 48 in the same plane.

The ninth type of framing element is a double-flanged, three-panel framing element 50. The double-flanged, three-panel framing element 42 is used along edges where three panels meet. The double-flanged, three-panel framing element 50 has sets of parallel flange extension 37 protruding from three adjacent sides of the tubular shaft 32. The parallel sets of flange extensions 37 are sized and positioned to receive the peripheral edge of three separate panels 22 (FIG. 2). Since double-flanged, three-panel framing elements 50 have parallel sets of flange extensions along three adjacent sides, three separate panels can be interconnected at 90-degree increments.

The tenth type of framing element shown is a double-flanged, four-sided framing element 52. The double-flanged, four-sided framing element 52 is used along edges where four panels meet. The double-flanged, four-sided framing element 52 has sets of parallel flange extensions 37 protruding from all four sides of the tubular shaft 32. The parallel sets of flange extensions 37 are sized and positioned to receive the peripheral edge of four separate panels 22 (FIG. 2).

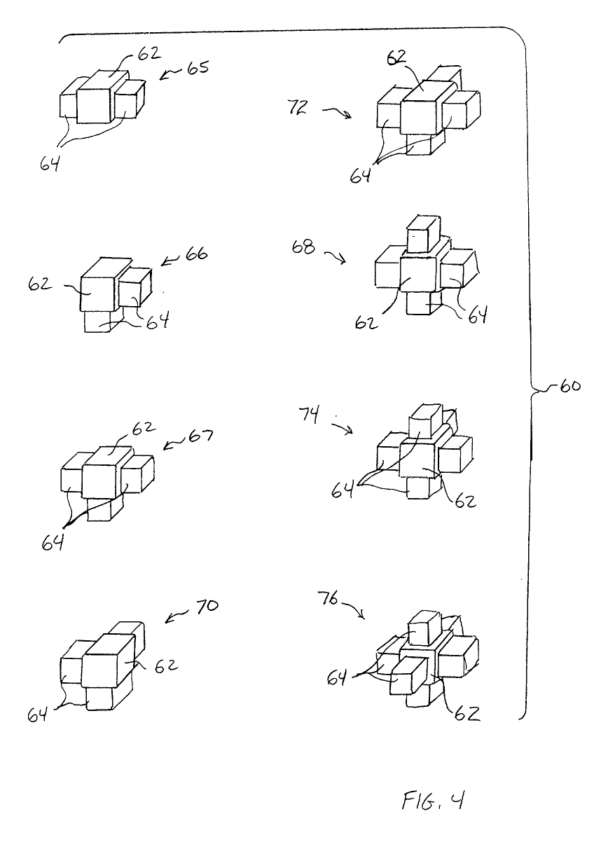

Referring to FIG. 4, it can be seen that there are eight basic types of connection brackets 60 that can be used in the present invention modular furniture system. The connection brackets 60 are used to interconnect the ends of the framing elements 30 (FIG. 3) to create a stable framework construction. Each of the connection brackets 60 has a central hub 52 and at least two extending arms 64. The central hub 62 has the same cross-sectional profile as does the tubular shaft 32 (FIG. 3) of a framing element 30 (FIG. 3). The extending arms 64 are sized to pass within the tubular shaft 32 (FIG. 3) of the various framing elements 30 (FIG. 3). Once the extending arm 64 of a connection bracket 50 passes into the open end of a framing element 30 (FIG. 3), the extending arm 64 engages the framing element with a friction fit. This interconnection can be reinforced with the use of adhesives or mechanical fasteners, such as screws.

The connection brackets 60 are the third family of component parts used in the present invention modular furniture system. Eight different connection brackets 60 are available for use. The first connection bracket is a straight bracket 65. This straight bracket 65 has two extending arms 64 arranged 1800 apart. As such, the straight bracket 65 can join any two framing elements 30 (FIG. 3) together in a linear orientation.

The second connection bracket 60 is a right angle bracket 66. The right angle bracket 66 has two extending arms 64 arranged 900 apart. As such, the right angle bracket 66 can join any two framing elements 30 (FIG. 3) together at a right angle.

The third connection bracket 60 is a T-shaped bracket 67. The T-shaped bracket 67 has three extending arms 64 arranged 90° apart in the same plane. As such, the T-shaped bracket 67 can join any three framing elements 30 (FIG. 3) together at right angles in the same plane.

The fourth connection bracket 60 is a cross-shaped bracket 68. The cross-shaped bracket 68 has four extending arms 64 arranged 900 apart in the same plane. As such, the cross-shaped bracket 68 can join any four framing elements 30 (FIG. 3) together at right angles in the same plane.

The fifth connection bracket 60 is a three-sided bracket 70. The three sided bracket 70 has three extending arms 64 arranged 90° apart along three separate axes. As such, the three-sided bracket 60 can join any three framing elements 30 (FIG. 3) together at right angles in three separate axes.

The sixth connection bracket 60 is a four-sided bracket 72. The four sided bracket 72 has four extending arms 74 arranged 90° apart. However, three of the arms 64 are in a common plane and one of the extending arms is in a perpendicular plane. As such, the four-sided bracket 72 can join any four framing elements 60 (FIG. 3) together at right angles in three separate axes.

The seventh connection bracket 60 is a five-sided bracket 74. The five sided bracket 74 has five extending arms 64 arranged 90° apart. However, four of the arms 64 are in a common plane and one of the extending arms is in a perpendicular plane. As such, the five-sided bracket can join any five framing elements 30 (FIG. 2) together at right angles in three separate axes.

The eighth connection bracket 60 is a six-sided bracket 76. The six sided bracket 76 has six extending arms 64 arranged 90° apart. However, four of the arms 64 are in a common plane and two of the extending arms 64 are linearly aligned in a perpendicular plane. As such, the bracket can join any six framing elements 30 (FIG. 3) together at right angles in three separate axes.

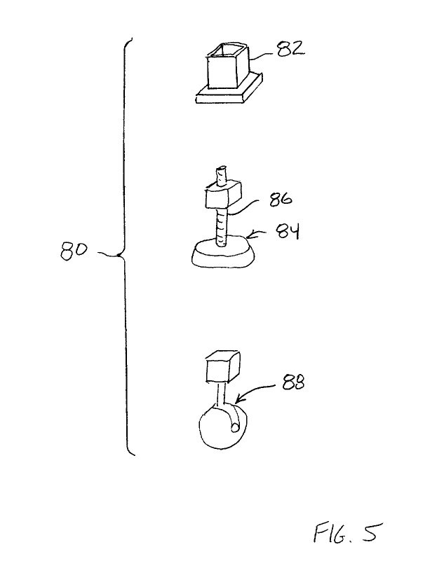

Referring to FIG. 5, the family of parts herein referred to as end terminations 80 are shown. The end terminations 80 pass into open ends of framing elements 30 (FIG. 3), thereby sealing the framing elements. In FIG. 5, a plain end termination 82 is shown that can seal the open end of an exposed framing element 30 (FIG. 3) in an aesthetically appealing manner. Two other end terminations are also shown. These end terminations are used to terminate support legs at the point where the framing supports 30 (FIG. 5) touch the ground. One leg end termination 84 has a height adjustment screw 86. The third end termination 88 has a rolling wheel.

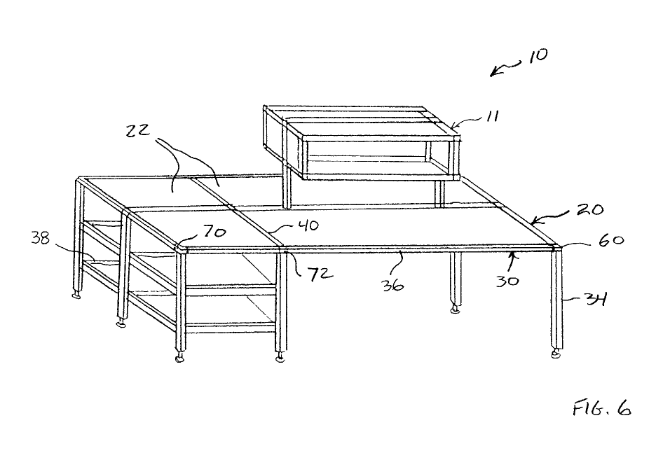

Referring to FIG. 6, it will be understood that to utilize the present invention modular furniture system 10, the size and function of the furniture to be created is first determined. Once a customer decides on what size and shape the furniture should be, the various component parts needed to construct that furniture design are supplied. The actual piece of modular furniture is then assembled on the customer's premises. As such, pieces of furniture much too large to be carried into a customer's premises pre-assembled can be easily constructed in place.

Once the size and shape of the piece of furniture is selected, and the component pieces delivered to the customer's premises, the furniture is assembled. As can be seen from FIG. 6, the piece of modular furniture constructed uses many of the component parts previously described. The modular piece of furniture is comprised of a framework 20 and panels 22. The framework 20 is comprised of different lengths and types of framing elements 30 that are joined together by connection brackets 60. Any open end of a framing element 30 is covered with an end termination 80. In FIG. 6, it can be seen that plain framing elements 34 are used as legs and as isolated vertical supports. Single panel framing elements 36 are used along the peripheral edge of the workstation 11, where the single panel framing elements 36 engage a single horizontal panel 22. Right angle framing elements 38 are used along edges where two panels 22 meet at right angles. Two sided framing elements 40 are used where two panels 22 abut in the same plane.

All of the framing elements 30 are joined together by connection brackets 60. In the shown embodiment, the corners of the workstation 11 are joined together by three sided brackets 70, because three framing elements 30 meet at these points. The plain framing elements 34 that create the support legs are joined to the framework 20 by four sided connection brackets 72. All of the connection brackets illustrated in FIG. 4 can be used depending upon the number of framing elements 30 and angles of the framing elements 30 converging at common points in the framework 20.

It will be understood that the present invention system and the method of assembly that are described and illustrated are merely exemplary and a person skilled in the art can make many variations to the shown embodiment. For example, the shape and style of the piece of furniture illustrated can be changed into countless different configurations. It is the function of the present invention modular furniture system to provide a system where a few basic component parts can be used to create furniture in many different shapes and styles. All such alternate embodiments and modifications are intended to be included within the scope of the present invention as defined below in the claims.

What is claimed is:

1. A modular furniture system, comprising:
a plurality of panels, wherein each panel has a flat top surface and a flat bottom surface joined along a common peripheral edge;
a plurality of framing elements, each of said framing elements having a tubular structure with open ends, wherein at least some of said framing elements have protrusions extending therefrom that engage said peripheral edge of at least one of said panels;
a plurality of brackets, each of said brackets having arms that pass into, and engage, the open end of at least two of said framing elements.

2. The system according to claim 1, wherein said plurality of framing elements include plain framing elements that do not engage any of said panels, single panel framing elements that engage a single panel, double panel framing elements that engage two of said panels 180° apart, right angle framing elements that engage two of said panels 90° apart, and three panel framing elements that engage three of said panels 90° apart.

3. The system according to claim 2, wherein said plurality of framing elements further includes a four panel framing element that engages four of said panels, wherein each of the four panels are held in planes 90° apart by said four panel framing element.

4. The system according to claim 1, wherein said plurality of brackets include two arm brackets that join two of said framing elements together, three arm brackets that join three of said framing elements together, four arm brackets that join four of said framing elements together, five arm brackets that join five of said framing elements together and six arm brackets that join six of said framing elements together.

5. The system according to claim 4, wherein said two arm brackets include straight brackets that join two of said framing elements together in a linear orientation and right angle brackets that join two of said framing elements together at a right angle.

6. The system according to claim 4, wherein said three arm brackets include T-shaped brackets that join together three of said framing elements in a T-shaped configuration, and three arm brackets that join together three of said framing elements along three separate axes

7. The system according to claim 4, wherein said four arm brackets include cross-shaped brackets that join together four of said framing elements in a cross-shaped configuration and four arm brackets that join four of said framing elements together in three different axes.

8. The system according to claim 1, at least some of said framing elements contain flange extensions that extend from the framing elements and crate support surfaces upon which said panels can rest.

9. The system according to claim 1, further including termination elements for engaging one of said open ends of said framing elements.

10. The system according to claim 9, wherein said termination elements are selected from a group consisting of plain terminations, adjustable height terminations and wheeled terminations.

11. The system according to claim 1, wherein each of said framing elements has a tubular structure with a predetermined cross-sectional shape and each of said brackets has a central base from which said arms extend, said central base having the same cross-sectional profile as said tubular structure.

12. The system according to claim 1, wherein said arms of said brackets pass into said open ends of said framing elements and engage said framing elements with a frictional fit.

13. A method of constructing a piece of furniture, comprising the steps of:
providing a plurality of tubular framing elements that have open ends;
providing a plurality of brackets that mechanically engage said open ends of said tubular framing elements, wherein said tubular framing elements and said brackets can be configured into a rigid furniture framework that contains at least one area defined on four sides by tubular framing elements;
providing at least one planar panel; and
assembling said at least one planar panel into said framework so that said at least one planar panel spans said at least one area supported by said framing elements.

14. The method according to claim 13, wherein said step of assembling said at least one planar panel into said framework includes mechanically interconnecting said planar panel to said framing elements that define said at least one area.

15. The method according to claim 13, wherein said step of providing a plurality of framing elements includes providing plain framing elements that do not engage any of said panels, providing single panel framing elements that can engage a single panel, providing double panel framing elements that can engage two panels 180° apart, providing right angle framing elements that can engage two panels 90° apart, and providing three panel framing elements that can engage three panels 90° apart.

16. The method according to claim 13, wherein said step of providing a plurality of framing elements further includes providing four panel framing elements that can engage four panels, wherein each of the four panels are held in planes 90° apart by said four panel framing element.

17. The system according to claim 13, wherein said step of providing a plurality of brackets includes providing two arm brackets that join two of said framing elements together, providing three arm brackets that join three of said framing elements together, providing four arm brackets that join four of said framing elements together, providing five arm brackets that join five of said framing elements together and providing six arm brackets that join six of said framing elements together.

18. A piece of furniture, comprising:
a framework comprised of linear tubular framing elements joined together by separable brackets that selectively engage the interior of the tubular framing elements, said framework having at least one area defined by four of said framing elements;
at least one panel disposed in said at least one area, wherein said panel engages and is supported by said four of said framing elements.

19. The furniture according to claim 18, wherein said tubular faming elements defining said at least one area have flanges that extend into said at least one area, wherein said at least one panel rest upon said flanges.
